(19) United States
(12) Patent Application Publication
(10) Pub. No.: US 2025/0273788 A1
(43) Pub. Date: Aug. 28, 2025

(54) STRAPS FOR SUPPORTING A BATTERY PACK

(71) Applicant: Rivian IP Holdings, LLC, Irvine, CA (US)

(72) Inventors: Sharbel ELKANTATI, Windsor (CA); Ryan ARENS, Irvine, CA (US); Bruce Philip EDWARDS, Menlo Park, CA (US); Mandar VAIDYA, Farmington, MI (US); Mohamed DARSOT, Troy, MI (US); John BERGER, Normal, IL (US)

(21) Appl. No.: 18/586,347

(22) Filed: Feb. 23, 2024

(51) Int. Cl. H01M 50/242; H01M 50/249; H01M 50/262; H01M 50/291

(52) U.S. Cl. CPC H01M 50/242; H01M 50/249; H01M 50/262; H01M 50/291; H01M 2220/20

(57) ABSTRACT

A battery pack may include one or more structural members, with at least some of the structural members coupled with one or more straps. The straps are designed and positioned to support the structural members. For example, in the event of an applied force to the battery pack, the applied force may cause the straps to bend. However, the straps may be pulled in tension as a result, and provide a counterforce. The counterforce provided by the straps may provide the structural members assembly with added resistance to withstand the impact from the applied force.

### INTRODUCTION

Batteries are often used as a source of power, including as a source of power for electric vehicles that include wheels that are driven by an electric motor that receives power from the batteries. A battery may include several battery cells carried within a module and/or a carrier.

Aspects of the subject technology can help to improve the durability and longevity of batteries of electric vehicles, which can help to mitigate climate change by reducing greenhouse gas emissions.

### SUMMARY

Vehicles with battery packs may include structural members (e.g., cross members, longitudinal member) that provide structural support. In one or more implementations, the structural members are supported using one or more straps. Structural members may absorb forces or other forms of impact to the battery pack. In order to structurally support the structural members, one or more straps may integrated with the structural members. The straps are designed to counter or offset a force applied directly or indirectly to the battery pack, such as from contact by a foreign object during an off-road event by the vehicle. As a result, c structural members in a battery pack can better withstand applied forces.

In one or more aspects of the present disclosure, an apparatus may be described. The apparatus may include a structural member having a first portion and a second portion opposite the first portion. The structural member may be positioned in a battery subassembly. The apparatus may further include a first strap coupled to the first portion. The apparatus may further include a second strap coupled to the second portion.

The first strap may include a first metal strap bolted to the first portion. The first strap may include a first shape. The second strap may include a second metal strap bolted to the second portion. The second strap may include a second shape different from the first shape. The first strap may be welded to a lid, and the lid may be configured to cover the battery subassembly. The structural member may include an indentation, and the first strap may be positioned over the indentation. The structural member may include a first structural component coupled with the first strap and including the indentation The structural member may further include a second structural component coupled with the second strap and including an opening configured to receive one or more fluid lines.

The first strap may be coupled with the first structural component by i) a first fastener passing through the first structural component and ii) a second fastener passing through the first structural component, and the indentation may be disposed between the first fastener and the second fastener. The second strap may include an asymmetric shape, and based on the asymmetric shape, the second strap may be configured to be positioned in a cavity of a skid plate coupled with the battery subassembly. The asymmetric shape of the second strap may include a first plate portion including a first opening. The asymmetric shape may further include a second plate portion including a second opening. The asymmetric shape may further include a third plate portion positioned between the first plate portion and the second plate portion. The third plate portion may be elevated with respect to the first plate portion and the second plate portion. The third plate portion may include a planar portion a non-planar portion extending from the planar portion. The structural member may include a cross member assembly that may include a first cross member component and a second cross member component.

In one or more aspects of the present disclosure, a battery subassembly may be described. The battery subassembly may include an enclosure that form in part a frame. The battery subassembly may further include a structural member coupled with the enclosure and the first strap. The first strap may be configured to prevent the structural member from bending based on an applied force to the frame. The battery subassembly may further include a second strap coupled with the structural member and configured to further prevent the structural member from bending based on the applied force. The battery subassembly may further include a skid plate. The skid plate may include a cavity, and the second strap may be located in the cavity and coupled with the skid plate. The battery subassembly may further include a lid that covers the structural member. The first strap may be welded to the lid.

The first strap may include a symmetric shape, and the second strap may include an asymmetric shape. The battery subassembly may further include a battery module. The structural member may include a longitudinal member that spans a length of the battery module. The structural member may include an indentation, and the first strap may cover the indentation.

In one or more aspects of the present disclosure, a vehicle may be described. The vehicle may include a battery subassembly including a plurality of straps coupled with a cross member assembly. The plurality of straps may be configured to be pulled in tension in response to an applied force to the battery subassembly or a skid plate covering the cross member assembly. The plurality of straps may include a first metal strap coupled with a first cross member of the cross member assembly, and a second metal strap coupled with a second cross member of the cross member assembly. The vehicle may further include a lid that covers the battery subassembly. The first metal strap may be coupled with the lid. The plurality of straps may be bolted to opposing ends of the cross member assembly.

### BRIEF DESCRIPTION OF THE DRAWINGS

Certain features of the subject technology are set forth in the appended claims. However, for purpose of explanation, several embodiments of the subject technology are set forth in the following figures.

FIG. 1A and FIG. 1B illustrate schematic perspective side views of example implementations of a vehicle having a battery pack, in accordance with one or more implementations of the present disclosure.

FIG. 1C illustrates a schematic perspective view of a building having a battery pack, in accordance with one or more implementations of the present disclosure.

FIG. 2A illustrates a schematic perspective view of a battery pack, in accordance with one or more implementations of the present disclosure.

FIG. 2B illustrates schematic perspective views of various battery modules that may be included in a battery pack, in accordance with one or more implementations of the present disclosure.

FIG. 2C illustrates a cross-sectional end view of a battery cell, in accordance with one or more implementations of the present disclosure.

FIG. 2D illustrates a cross-sectional perspective view of a cylindrical battery cell, in accordance with one or more implementations.

FIG. 2E illustrates a cross-sectional perspective view of a prismatic battery cell, in accordance with one or more implementations of the present disclosure.

FIG. 2F illustrates a cross-sectional perspective view of a pouch battery cell, in accordance with one or more implementations of the present disclosure.

FIG. 3 illustrates a perspective view of an enclosure for a battery pack in accordance with one or more implementations of the present disclosure.

FIG. 4 illustrates an exploded top view of an enclosure shown in FIG. 3 in accordance with one or more implementations of the present disclosure.

FIG. 5 illustrates an aerial view of a battery pack, showing several structural members of the battery pack in accordance with one or more implementations of the present disclosure.

FIG. 6 illustrates a perspective view of a battery pack in accordance with one or more implementations of the present disclosure.

FIG. 7 illustrates a partial cross sectional view of a battery pack, showing an example of a structural member in accordance with one or more implementations of the present disclosure.

FIG. 8 illustrates a perspective view of an example of a strap in accordance with one or more implementations of the present disclosure.

FIG. 9 illustrates a perspective view of an alternate example of a strap in accordance with one or more implementations of the present disclosure.

FIG. 10 illustrates a cross sectional view of the strap shown in FIG. 9, taken along line 10-10, in accordance with one or more implementations of the present disclosure.

FIG. 11 illustrates a side view of the straps shown in FIGS. 8 and 9, further showing the straps responding to an applied force in accordance with one or more implementations of the present disclosure.

FIG. 12 illustrates a perspective view of an alternate example of a battery pack and structural members in accordance with one or more implementations of the present disclosure.

FIG. 13 illustrates a flow diagram showing an example of a process that may be performed for assembling a battery subassembly in accordance with one or more implementations of the present disclosure.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

The present disclosure is generally directed to straps (e.g., metal bars) coupled with structural members (e.g., cross members, longitudinal members) in a battery pack, or battery subassembly. The straps are designed to counter at least some forces, or loads, applied to a vehicle. In particular, the straps minimize impact to structural members in the battery pack, which may occur in off-road applications in which a foreign object strikes the underside of the battery pack at or near the structural members. The straps may respond to a load applied to the battery pack by bending. The bending may cause the straps to be pulled in tension and resist the applied forces. Beneficially, the straps may limit or prevent fracturing or breaking of the structural member(s). Each of the straps may include different design configurations. For example, a lower strap may include an asymmetric shape, or design, and may be integrated with a skid plate in a pre-assembly operation. The upper strap may include a symmetric shape, or design, and may be welded to a lid of the battery pack. Each of the straps may be bolted to the structural member. In one or more implementations, the straps are ideally positioned as far as possible from the neutral axis of the structural member to more effectively counter loads applied to the structural member.

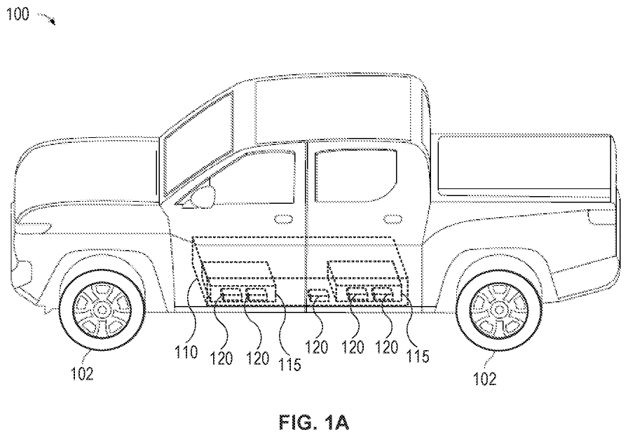

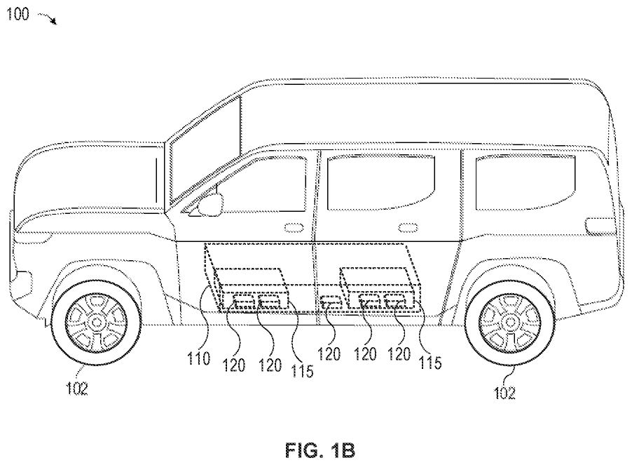

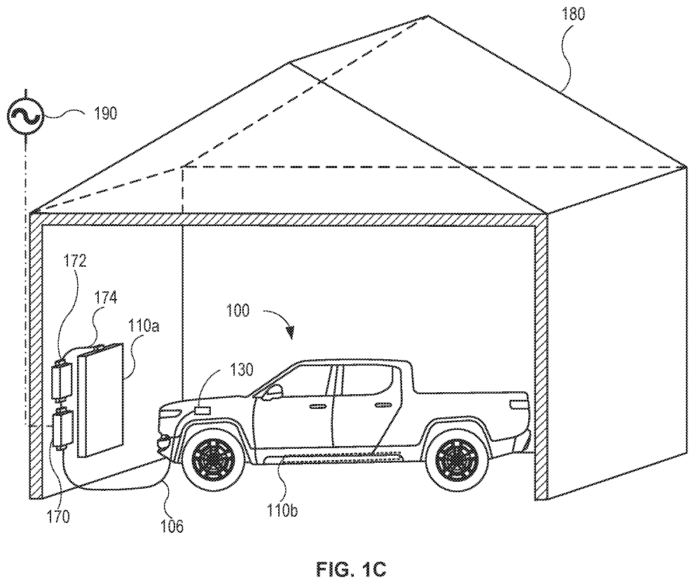

FIG. 1A illustrates an example implementation of a moveable device as described herein. In the example of FIG. 1A, a moveable device is implemented as a vehicle 100. As shown, the vehicle 100 may include one or more battery packs, such as battery pack 110. The battery pack 110 may be coupled to one or more electrical systems of the vehicle 100 to provide power to the electrical systems.

In one or more implementations, the vehicle 100 may be an electric vehicle having one or more electric motors that drive the wheels 102 of the vehicle 100 using electric power from the battery pack 110. In one or more implementations, the vehicle 100 may also, or alternatively, include one or more engines, or motors, including chemically-powered engines, such as a gas-powered engine or a fuel cell powered motor. For example, in one or more implementations, the vehicle 100 includes one or more electric motors, and the vehicle 100 takes the form of a fully electric or partially electric (e.g., hybrid or plug-in hybrid) vehicle.

In the example of FIG. 1A, the vehicle 100 is implemented as a truck (e.g., a pickup truck) having a battery pack 110. As shown, the battery pack 110 may include one or more battery modules 115, which may include one or more battery cells 120. As shown in FIG. 1A, the battery pack 110 may also, or alternatively, include one or more battery cells 120 mounted directly in the battery pack 110 (e.g., in a cell-to-pack configuration). In one or more implementations, the battery pack 110 may be provided without the battery modules 115 and with the battery cells 120 mounted directly in the battery pack 110 (e.g., in a cell-to-pack configuration) and/or in other battery units that are installed in the battery pack 110. The battery pack 110 may include multiple energy storage devices that can be arranged into such as battery modules or battery units. A battery unit or module can include an assembly of cells that can be combined with other elements (e.g., structural frame, thermal management devices) that can protect the assembly of cells from heat, shock and/or vibrations.

Each of the battery cells 120 may be included a battery, a battery unit, a battery module and/or a battery pack to power components of the vehicle 100. For example, a battery cell housing of the battery cells 120 can be disposed in the battery module 115, the battery pack 110, a battery array, or other battery unit installed in the vehicle 100.

As discussed in further detail hereinafter, the battery cells 120 may be provided with a battery cell housing that can be provided with any of various outer shapes. The battery cell housing may be a rigid housing in some implementations (e.g., for cylindrical or prismatic battery cells). The battery cell housing may also, or alternatively, be formed as a pouch or other flexible or malleable housing for the battery cell in some implementations. In various other implementations, the battery cell housing can be provided with any other suitable outer shape, such as a triangular outer shape, a square outer shape, a rectangular outer shape, a pentagonal outer shape, a hexagonal outer shape, or any other suitable outer shape. In some implementations, the battery pack 110 may not include modules (e.g., the battery pack may be module-free). For example, the battery pack 110 can have a module-free or cell-to-pack configuration in which the battery cells 120 are arranged directly into the battery pack 110 without assembly into a battery module 115. In one or more implementations, the vehicle 100 may include one or more busbars, electrical connectors, or other charge collecting, current collecting, and/or coupling components to provide electrical power from the battery pack 110 to various systems or components of the vehicle 100. In one or more implementations, the vehicle 100 may include control circuitry such as a power stage circuit that can be used to convert DC power from the battery pack 110 into AC power for one or more components and/or systems of the vehicle (e.g., including one or more power outlets of the vehicle). The power stage circuit can be provided as part of the battery pack 110 or separately from the battery pack 110 within the vehicle 100.

FIG. 1B illustrates another implementation in which the vehicle 100 is implemented as a sport utility vehicle (SUV), such as an electric sport utility vehicle. In the example of FIG. 1B, the vehicle 100 may include a cargo storage area that is enclosed within the vehicle 100 (e.g., behind a row of seats within a cabin of the vehicle 100). In other implementations, the vehicle 100 may be implemented as another type of electric truck, an electric delivery van, an electric automobile, an electric car, an electric motorcycle, an electric scooter, an electric bicycle, an electric passenger vehicle, an electric passenger or commercial truck, a hybrid vehicle, an aircraft, a watercraft, and/or any other movable device having a battery pack 110 (e.g., a battery pack or other battery unit that powers the propulsion or drive components of the moveable device).

In one or more implementations, the battery pack 110, battery modules 115, battery cells 120, and/or any other battery unit as described herein may also, or alternatively, be implemented as an electrical power supply and/or energy storage system in a building, such as a residential home or commercial building. For example, FIG. 1C illustrates an example in which a battery pack 110a is implemented in a building 180. The building 180 may be a residential building, a commercial building, or any other building. As shown, in one or more implementations, the battery pack 110a may be mounted to a wall of the building 180.

As shown, the battery pack 110a that is installed in the building 180 may be coupled (e.g., electrically coupled) to the battery pack 110b in the vehicle 100, such as via a cable/connector 106 that can be connected to a charging port 130 of the vehicle 100, an electric vehicle supply equipment 170 (EVSE), a power stage circuit 172, and/or a cable/connector 174. For example, the cable/connector 106 may be coupled to the EVSE 170, which may be coupled to the battery pack 110a via the power stage circuit 172, and/or may be coupled to an external power source 190. In this way, either the external power source 190 or the battery pack 110a may be used as an external power source to charge the battery pack 110b in some use cases. In one or more implementations, the battery pack 110a may also, or alternatively, be coupled (e.g., via a cable/connector 174, the power stage circuit 172, and the EVSE 170) to the external power source 190. The external power source 190 may take the form of a solar power source, a wind power source, and/or an electrical grid of a city, town, or other geographic region (e.g., electrical grid that is powered by a remote power plant). During, for example, instances when the battery pack 110b is not coupled to the battery pack 110a, the battery pack 110a may couple (e.g., using the power stage circuit 172) to the external power source 190 to charge up and store electrical energy. In some use cases, this stored electrical energy in the battery pack 110a may later be used to charge the battery pack 110b (e.g., during times when solar power or wind power is not available, in the case of a regional or local power outage for the building 180, and/or during a period of high rates for access to the electrical grid).

In one or more implementations, the power stage circuit 172 may electrically couple the battery pack 110a to an electrical system of the building 180. For example, the power stage circuit 172 may convert DC power from the battery pack 110a into AC power for one or more loads in the building 180. Exemplary loads coupled, via one or more electrical outlets coupled, to the battery pack 110a may include one or more lights, lamps, appliances, fans, heaters, air conditioners, and/or any other electrical components or electrical loads. The power stage circuit 172 may include control circuitry that is operable to switchably couple the battery pack 110a between the external power source 190 and one or more electrical outlets and/or other electrical loads in the electrical system of the building 180. In one or more implementations, the vehicle 100 may include a power stage circuit (not shown in FIG. 1C) that can be used to convert power received from the EVSE 170 to DC power that is used to power/charge the battery pack 110b, and/or to convert DC power from the battery pack 110 into AC power for one or more electrical systems, components, and/or loads of the vehicle 100.

In one or more use cases, the battery pack 110a may be used as a source of electrical power for the building 180, such as during times when solar power or wind power is not available, in the case of a regional or local power outage for the building 180, and/or during a period of high rates for access to the electrical grid, as non-limiting examples. In one or more other use cases, the battery pack 110b may be used to charge the battery pack 110a and/or to power the electrical system of the building 180 (e.g., in a use case in which the battery pack 110a is low on or out of stored energy and in which solar power or wind power is not available, a regional or local power outage occurs for the building 180, and/or a period of high rates for access to the electrical grid occurs, as non-limiting examples.

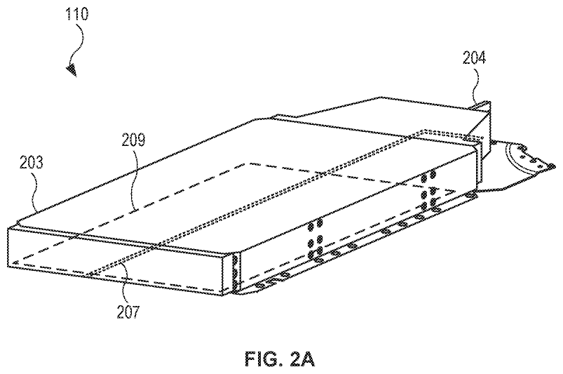

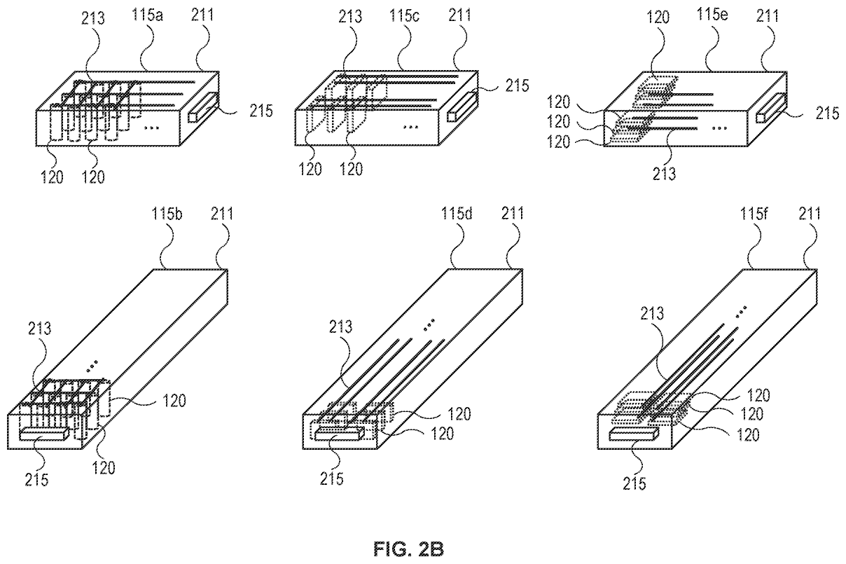

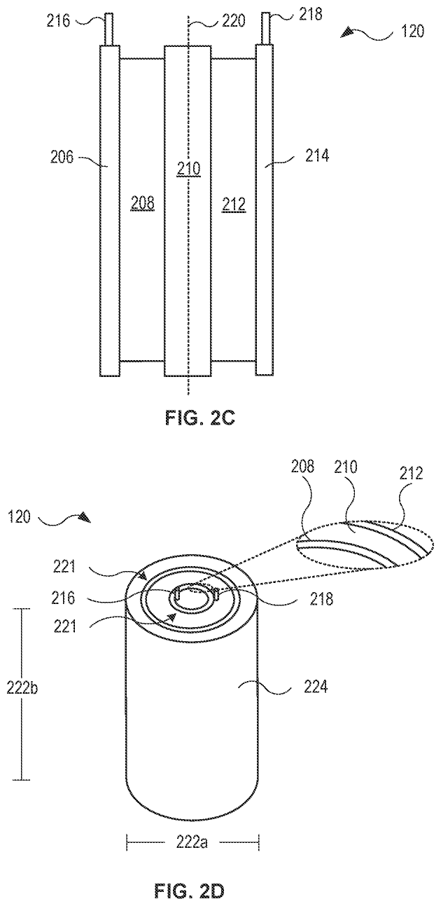

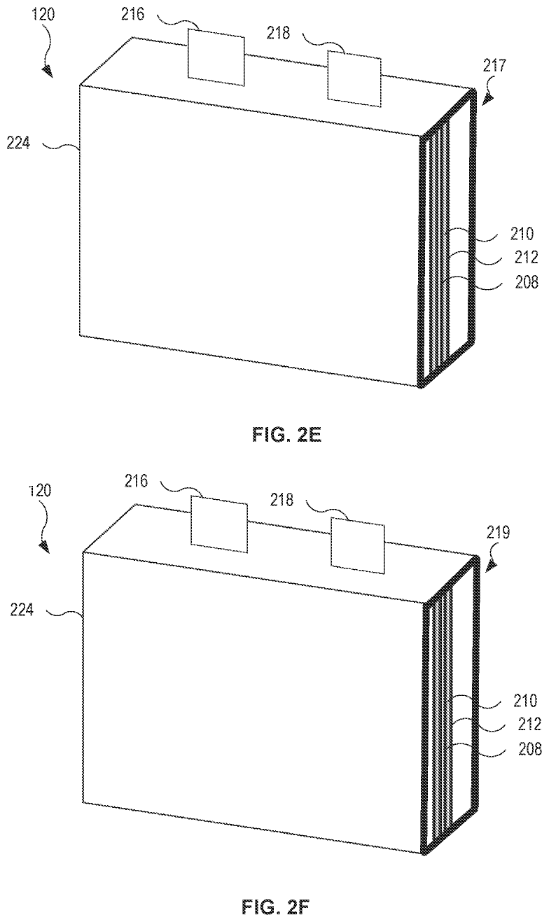

FIG. 2A illustrates an example of a battery pack 110. As shown, the battery pack 110 may include a battery pack frame 203 (e.g., a battery pack housing or pack frame). The battery pack frame 203 may house or enclose one or more battery modules and/or one or more battery cells, and/or other battery pack components of the battery pack 110. In one or more implementations, the battery pack frame 203 may include or form a shielding structure on an outer surface thereof (e.g., a bottom thereof and/or underneath one or more battery module, battery units, batteries, and/or battery cells) to protect the battery module, battery units, batteries, and/or battery cells from external conditions (e.g., if the battery pack 110 is installed in a vehicle and the vehicle is driven over rough terrain, such as off-road terrain, trenches, rocks, rivers, streams, etc.).

The battery pack 110 may include battery cells (e.g., directly installed within the battery pack 110, or within batteries, battery units, and/or battery modules as described herein) and/or battery modules, and one or more conductive coupling elements for coupling a voltage generated by the battery cells to a power-consuming component, such as the vehicle 100 (shown in FIGS. 1A, 1B, and 1C) and/or an electrical system of the building 180 (shown in FIG. 1C). For example, the conductive coupling elements may include internal connectors and/or contactors that couple together multiple battery cells, battery units, batteries, and/or multiple battery modules within the battery pack frame 203 to generate a desired output voltage for the battery pack 110. The battery pack 110 may also include one or more external connection ports, such as an electrical contact 204 (e.g., a high voltage terminal or connector). As shown, the battery pack 110 may include an electrical contact 204 may electrically couple an external load (e.g., the vehicle or an electrical system of the building) to the battery modules and/or battery cells in the battery pack 110. In this regard, an electrical cable (e.g., cable/connector 106) may be connected between the electrical contact 204 and an electrical system of a vehicle or a building, to provide electrical power to the vehicle or the building.

In one or more implementations, the battery pack 110 may include one or more thermal control structures 207 (e.g., cooling lines and/or plates and/or heating lines and/or plates). For example, thermal control structures 207 may couple thermal control structures and/or fluids to the battery modules, battery units, batteries, and/or battery cells within the battery pack frame 203, such as by distributing fluid through the battery pack 110. The thermal control structures 207 may form a part of a thermal/temperature control or heat exchange system that includes one or more thermal components 209, which may include plates or bladders that are disposed in thermal contact with one or more battery modules and/or battery cells disposed within the battery pack frame 203. The one or more thermal components 209 may be positioned in contact with one or more battery modules, battery units, batteries, and/or battery cells within the battery pack frame 203. The one or multiple thermal control structures 207 may be provided for each of several top and bottom battery module pairs.

FIG. 2B depicts various examples of battery modules that may be disposed in a battery pack (e.g., within the battery pack frame 203 of the battery pack 110, shown in FIG. 2A). In an example of FIG. 2B, a battery module 115a is shown that includes a battery module housing 211 having a rectangular cuboid shape with a length that is substantially similar to its width. In this example, the battery module 115a includes battery cells 120 implemented as cylindrical battery cells. The battery module 115a further includes rows and columns of cylindrical battery cells that are coupled together by an interconnect structure 213 (e.g., a current connector assembly or CCA). For example, the interconnect structure 213 may couple together the positive terminals of the battery cells 120, and/or couple together the negative battery terminals of the battery cells 120. As shown, the battery module 115a may further include a bus bar 215 that functions as a charge collector. For example, the bus bar 215 may be electrically coupled to the interconnect structure 213 to collect the charge generated by the battery cells 120 to provide a high voltage output from the battery module 115a.

FIG. 2B also shows a battery module 115b having an elongate shape. The battery module 115b may include a battery module housing 211 in which the length of the (e.g., extending along a direction from a front end to a rear end of the battery module housing 211) is substantially greater than a width (e.g., in a transverse direction to the direction from the front end to the rear end) of the battery module housing 211). In this regard, the battery module 115b (representative of one or more similar battery modules) may span the entire front-to-back length of a battery pack within a battery pack frame. As shown, the battery module 115a may further include an interconnect structure 213 electrically coupled to a bus bar 215, allowing the bus bar 215 may be electrically coupled to the interconnect structure 213 to collect the charge generated by battery cells 120 of the battery module 115b to provide a high voltage output from the battery module 115b.

In the implementations of battery module 115a and battery module 115a, the battery cells 120 are implemented as cylindrical battery cells. However, in other implementations, a battery module may include battery cells having other form factors, such as a battery cells having a right prismatic outer shape (e.g., a prismatic cell), or a pouch cell implementation of a battery cell. As an example, FIG. 2B also shows a battery module 115c having a battery module housing 211 with a rectangular cuboid shape with a length that is substantially similar to its width and including battery cells 120 implemented as prismatic battery cells. In this example, the battery module 115c includes rows and columns of battery cells 120 that are coupled together by an interconnect structure 213 (e.g., a current collector assembly or CCA). For example, the interconnect structure 213 may couple together the positive terminals of the battery cells 120 and/or couple together the negative battery terminals of the battery cells 120. As shown, the battery module 115c may include a bus bar 215 that functions as a charge collector. For example, the bus bar 215 may be electrically coupled to the interconnect structure 213 to collect the charge generated by the battery cells 120 to provide a high voltage output from the battery module 115c.

FIG. 2B also shows a battery module 115d including prismatic battery cells and having an elongate shape. For example, the battery module 115d includes a battery module housing 211 in which the length of the battery module housing 211 is substantially greater than a width of the battery module housing 211. In this regard, the battery module 115d (representative of one or more similar battery modules) may span the entire front-to-back length of a battery pack within a battery pack frame. As shown, the battery module 115d may also include an interconnect structure 213 and a bus bar 215 electrically coupled to the interconnect structure 213. For example, the bus bar 215 may be electrically coupled to the interconnect structure 213 to collect the charge generated by the battery cells 120 to provide a high voltage output from the battery module 115d.

As another example, FIG. 2B also shows a battery module 115e having a battery module housing 211 having a rectangular cuboid shape with a length that is substantially similar to its width. The battery module housing 211 may carry battery cells 120, each of which being implemented as pouch battery cells. In this example, the battery module 115e includes rows and columns of pouch battery cells that are coupled together by an interconnect structure 213 (e.g., a current collector assembly or CCA). For example, the interconnect structure 213 may couple together the positive terminals of the battery cells 120 and couple together the negative battery terminals of the battery cells 120. As shown, the battery module 115e may also include a bus bar 215 electrically coupled to the interconnect structure 213. For example, the bus bar 215 may be electrically coupled to the interconnect structure 213 to collect the charge generated by the battery cells 120 to provide a high voltage output from the battery module 115e.

FIG. 2B also shows a battery module 115f including pouch battery cells and having an elongate shape. For example, the battery module 115d includes a battery module housing 211 in which the length of the battery module housing 211 is substantially greater than a width of the battery module housing 211. In this regard, the battery module 115d (representative of one or more similar battery modules) may span the entire front-to-back length of a battery pack within a battery pack frame. In this regard, the battery module 115f (representative of one or more similar battery modules) may span the entire front-to-back length of a battery pack within a battery pack frame. As shown, the battery module 115f may also include an interconnect structure 213 and a bus bar 215 electrically coupled to the interconnect structure 213. For example, the bus bar 215 may be electrically coupled to the interconnect structure 213 to collect the charge generated by the battery cells 120 to provide a high voltage output from the battery module 115f.

In various implementations, a battery pack (e.g., battery pack 110 shown in FIG. 2A) may be provided with one or more of any of the battery modules 115a, 115b, 115c, 115d, 115e, and 115f. In one or more other implementations, a battery pack may be provided without any of the battery modules 115a, 115b, 115c, 115d, 115e, and 115f (e.g., in a cell-to-pack implementation).

In one or more implementations, battery modules in any of the implementations of FIG. 2B may be coupled (e.g., in series) to a current collector of a battery pack. In one or more implementations, the current collector may be coupled, via a high voltage harness, to one or more external connectors on a battery pack (e.g., electrical contact 204 of the battery pack 110, shown in FIG. 2A). In one or more implementations, a battery pack may be provided without any battery modules 115. For example, in a cell-to-pack configuration, the battery cells 120 are arranged directly into a battery pack without assembly into a battery module (e.g., without including the battery module housing 211). For example, a battery pack frame of a battery pack (e.g., the battery pack frame 203 of the battery pack 110 shown in FIG. 2A) may include or define a plurality of structures for positioning of the battery cells 120 directly within the battery pack frame.

FIG. 2C illustrates a cross-sectional end view of a portion of a battery cell 120. As shown, the battery cell 120 may include an anode 208, an electrolyte 210, and a cathode 212. As shown, the anode 208 may include or be electrically coupled to a first current collector 206 (e.g., a metal layer such as a layer of copper foil or other metal foil). Also, the cathode 212 may include or be electrically coupled to a second current collector 214 (e.g., a metal layer such as a layer of aluminum foil or other metal foil). The battery cell 120 may further include a terminal 216 coupled to the anode 208 (e.g., via the first current collector 206) and a terminal 218 coupled to the cathode (e.g., via the second current collector 214). One of the terminals 216 and 218 may be assigned a positive terminal and the other may be assigned a negative terminal. In various implementations, the electrolyte 210 may take the form of a liquid electrolyte layer or a solid electrolyte layer. In one or more implementations in which the electrolyte 210 is a liquid electrolyte layer, the battery cell 120 may include a separator layer 220 that separates the anode 208 from the cathode 212. In one or more implementations in which the electrolyte 210 is a solid electrolyte layer, the electrolyte 210 may function as both separator layer and an electrolyte layer.

In one or more implementations, the battery cell 120 may be implemented as a lithium ion battery cell in which the anode 208 is formed from a carbonaceous material (e.g., graphite or silicon-carbon). In these implementations, lithium ions can move from the anode 208, through the electrolyte 210, to the cathode 212 during discharge of the battery cell 120 (e.g., and through the electrolyte 210 from the cathode 212 to the anode 208 during charging of the battery cell 120). For example, the anode 208 may be formed from a graphite material that is coated on a copper foil corresponding to the first current collector 206. In these lithium ion implementations, the cathode 212 may be formed from one or more metal oxides (e.g., a lithium cobalt oxide, a lithium manganese oxide, a lithium nickel manganese cobalt oxide (NMC), or the like) and/or a lithium iron phosphate. In an implementation in which the battery cell 120 is implemented as a lithium-ion battery cell, the electrolyte 210 may include a lithium salt in an organic solvent.

The separator layer 220 may be formed from one or more insulating materials (e.g., a polymer such as polyethylene, polypropylene, polyolefin, and/or polyamide, or other insulating materials such as rubber, glass, cellulose or the like). The separator layer 220 may prevent contact between the anode 208 and the cathode 212, and may be permeable to the electrolyte 210 and/or ions within the electrolyte 210. In one or more implementations, the battery cell 120 may be implemented as a lithium polymer battery cell having a dry solid polymer electrolyte and/or a gel polymer electrolyte.

Although some examples are described herein in which the battery cell 120 is implemented as lithium-ion battery cells, the battery cell 120 may be implemented using other battery cell technologies, such as nickel-metal hydride battery cells, lead-acid battery cells, and/or ultracapacitor cells. For example, in a nickel-metal hydride battery cell, the anode 208 may be formed from a hydrogen-absorbing alloy and the cathode 212 may be formed from a nickel oxide-hydroxide. In the example of a nickel-metal hydride battery cell, the electrolyte 210 may be formed from an aqueous potassium hydroxide in one or more examples.

The battery cell 120 may be implemented as a lithium sulfur battery cell in one or more other implementations. For example, in a lithium sulfur battery cell, the anode 208 may be formed at least in part from lithium, the cathode 212 may be formed from at least in part form sulfur, and the electrolyte 210 may be formed from a cyclic ether, a short-chain ether, a glycol ether, an ionic liquid, a super-saturated salt-solvent mixture, a polymer-gelled organic media, a solid polymer, a solid inorganic glass, and/or other suitable electrolyte materials. In various implementations, the anode 208, the electrolyte 210, and the cathode 212 can be packaged into a battery cell housing having any of various shapes, and/or sizes, and/or formed from any of various suitable materials. For example, the battery cell 120 may include a cylindrical, rectangular, square, cubic, flat, pouch, elongated, or prismatic outer shape.

As depicted in FIG. 2D, for example, a battery cell 120 may be implemented as a cylindrical cell. Accordingly, the battery cell 120 includes dimension 222a (e.g., cylinder diameter, battery cell diameter) and a dimension 222b (e.g., cylinder length). The battery cell 120, and other battery cells described herein, may include dimensional information derived from a 4-number code. For example, in some embodiments, the battery cell 120 includes an XXYY battery cell, in which “XX” refers to the dimension 222a in millimeters (mm) and “YY” refers to the dimension in mm. Accordingly, when the battery cell 120 includes a “2170” battery cell, the dimension 222a is 21 mm and the dimensions 222b is 70 mm. Alternatively, when the battery cell 120 includes a “4680” battery cell, the dimension 222a is 46 mm and the dimensions 222b is 80 mm. The foregoing examples of dimensional characteristics for the battery cell 120 should not be construed as limiting, and the battery cell 120, and other battery cells described herein with a cylindrical form factor, may include various dimension. For example, the dimension 222a and the dimension 222b may be greater than 46 mm and 80 mm, respectively.

FIG. 2D illustrates a battery cell 120 that includes a cell housing 224 having a cylindrical outer shape. As shown in the enlarged view, the anode 208, the electrolyte 210, and the cathode 212 may be rolled into one or more windings 221. The one or more windings 221 may include one or more substantially cylindrical windings, as a non-limiting example. As shown, one or more windings 221 of the anode 208, the electrolyte 210, and the cathode 212 (e.g., and/or one or more separator layers such as separator layer 220 shown in FIG. 2C) may be disposed within the cell housing 224. For example, a separator layer may be disposed between adjacent ones of the one or more windings 221. Additionally, the battery cell 120 in the cylindrical cell implementation of FIG. 2D includes a terminal 216 and a terminal 218. The terminal 218 may include a first polarity terminal, such as a positive terminal, which is coupled to the cathode 212. The terminal 216 may include a second polarity terminal, such as a negative terminal, which is coupled to the anode 208. The terminals 216 and 218 can be made from electrically conductive materials to carry electrical current from the battery cell 120 directly or indirectly (e.g., via a current carrier assembly, a bus bar, and/or other electrical coupling structures) to an electrical load, such as a component or system of a vehicle or a building shown and/or described herein. However, the cylindrical cell implementation of FIG. 2D is merely illustrative, and other implementations of the battery cells 120 are contemplated.

FIG. 2E illustrates an example in which the battery cell 120 is implemented as a prismatic cell. As shown, the battery cell 120 may include a cell housing 224 having a right prismatic outer shape. Also, one or more layers of the anode 208, the cathode 212, and the electrolyte 210 disposed therebetween may be disposed (e.g., with separator materials between the layers) within the cell housing 224. As examples, multiple layers of the anode 208, electrolyte 210, and cathode 212 can be stacked (e.g., with separator materials between each layer), or a single layer of the anode 208, electrolyte 210, and cathode 212 can be formed into a flattened spiral shape and provided in the cell housing 224. The cell housing 224 may include a cross-sectional width 217 that is relatively thick and is formed from a rigid material. For example, the cell housing 224 may be formed from a welded, stamped, deep drawn, and/or impact extruded metal sheet, such as a welded, stamped, deep drawn, and/or impact extruded aluminum sheet. The cross-sectional width 217 of the cell housing 224 may be as much as, or more than 1 millimeter (mm) to provide a rigid housing for the prismatic battery cell. In one or more implementations, a terminal 216 and a terminal 218 in the prismatic cell implementation of FIG. 2E may be formed from a feedthrough conductor that is insulated from the cell housing 224 (e.g., a glass to metal feedthrough) as the conductor passes through to cell housing 224 to expose the terminal 216 and the terminal 218 outside the cell housing 224 in order to contact an interconnect structure (e.g., interconnect structure 213 shown in FIG. 2B). However, this implementation of FIG. 2E is also illustrative and yet other implementations of the battery cell 120 are contemplated.

FIG. 2F illustrates an example in which the battery cell 120 is implemented as a pouch cell. As shown, the battery cell 120 may include a cell housing 224 that forms a flexible or malleable pouch housing. One or more layers of the anode 208, the cathode 212, and the electrolyte 210 disposed therebetween may be disposed (e.g., with separator materials between the layers) within the cell housing 224. In the implementation of FIG. 2F, the cell housing 224 may include a cross-sectional width 219 that is relatively thin. For example, the cell housing 224 in the implementation of FIG. 2F may be formed from a flexible or malleable material (e.g., a foil, such as a metal foil, or film, such as an aluminum-coated plastic film). The cross-sectional width 219 of the cell housing 224 may be as low as, or less than, 0.1 mm, 0.05 mm, 0.02 mm, or 0.01 mm to provide flexible or malleable housing for the pouch battery cell. In one or more implementations, a terminal 216 and a terminal 218 in the pouch cell implementation of FIG. 2F may be formed from conductive tabs (e.g., foil tabs) that are coupled (e.g., welded) to the anode 208 and the cathode 212 respectively, and sealed to the pouch that forms the cell housing 224 in these implementations. In the examples of FIGS. 2C, 2E, and 2F, the terminal 216 and the terminal 218 are formed on the same side (e.g., a top side) of the battery cell 120. However, this is merely illustrative and, in other implementations, the terminal 216 and the terminal 218 may formed on two different sides (e.g., opposing sides, such as a top side and a bottom side) of the battery cell 120. The terminal 216 and the terminal 218 may be formed on a same side or difference sides of the cylindrical cell of FIG. 2D in various implementations.

In one or more implementations, a battery module, a battery pack, a battery unit, or any other battery may include some battery cells that are implemented as solid-state battery cells and other battery cells that are implemented with liquid electrolytes for lithium-ion or other battery cells having liquid electrolytes. In one or more implementations, one or more of the battery cells may be included a battery module or a battery pack, such as to provide an electrical power supply for components of a vehicle and/or a building previously described, or any other electrically powered component or device. A cell housing of the battery cell can be disposed in the battery module, the battery pack, or installed in any of the vehicle, the building, or any other electrically powered component or device.

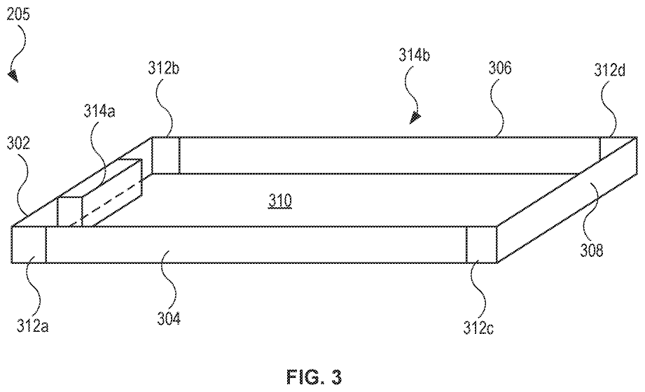

FIG. 3 illustrates a perspective view of an enclosure 205 for a battery pack (e.g., battery pack 110 shown in FIG. 1A). In this example, the enclosure 205 may include a casted member 302, a sidewall structure 304 (e.g., a siderail or extruded sidewall), a sidewall structure 306 (e.g., a siderail or extruded sidewall), a casted member 308, and a bottom plate 310. Each of the casted members 302 and 308 may take the form of a monolithic, unitary member formed from, for example, metal (e.g., aluminum, steel, another metal, and/or an alloy thereof) in a casting operation (e.g., a die casting operation). Further, the casted member 302 may take the form of a casted front wall or front member for the enclosure 205, configured for positioning near or toward a front of a vehicle in which a battery pack is installed. In this regard, the casted member 302 may include an outer surface that defines the front surface of the enclosure 205 and a battery pack positioned in the enclosure 205. As shown, the casted member 302 may include an end portion 312a and an end portion 312b (e.g., corner portions) that bend away from the front wall to form respective portions of respective sidewalls of the enclosure 205. The casted member 308 may take the form of a casted rear member for the enclosure 205, configured for positioning near or toward a rear of a vehicle in which a battery pack is installed. In this regard, the casted member 308 may form a rear wall of the enclosure 205, and may include an outer surface that defines the rear surface of the enclosure 205 and a battery pack positioned in the enclosure 205. As shown, the casted member 308 may include an end portion 312c and an end portion 312d (e.g., corner portions) that bend way from the rear wall to form respective portions of the respective sidewalls of the enclosure 205. Also, each of the sidewall structures 304 and 306 may take the form of a single monolithic unitary structure that has been formed from, for example, metal (e.g., aluminum, steel, another metal, and/or an alloy thereof) in an extrusion operation.

Also, the casted member 302 may include and/or define a cavity 314a. In one or more implementations, the cavity 314a may be configured to enclose electrical circuitry, such as a high voltage distribution box (HVDB) that is electrically coupled to one or more battery modules and/or battery cells of a battery pack (e.g., battery modules 115, battery cells 120, battery pack 110 shown in FIG. 1A). For example, the battery modules and/or battery cells may be enclosed in a cavity 314b (e.g., an additional cavity) separate from the cavity 314a, defined in part by the sidewall structure 304 and the sidewall structure 306.

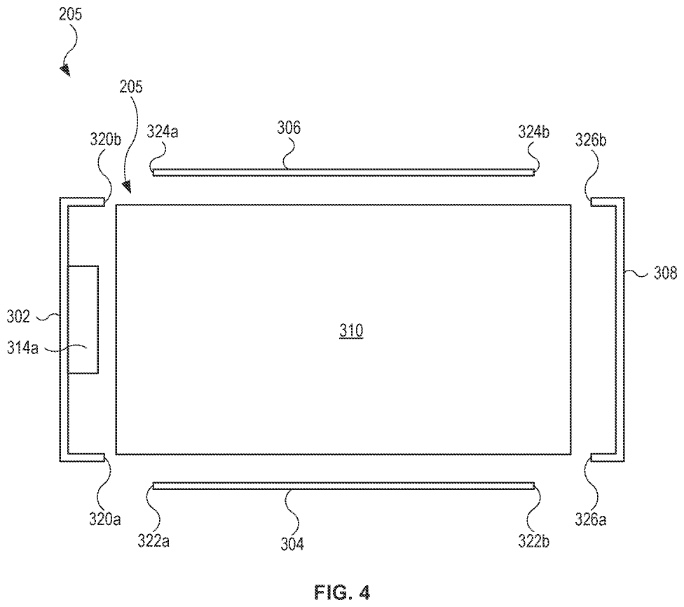

FIG. 4 illustrates an exploded top view of the enclosure 205 shown in FIG. 3. As shown in FIG. 4, the casted member 302 may include an end surface 320a and an end surface 320b. Further, the sidewall structure 304 and the sidewall structure 306 may include an end surface 322a and an end surface 324a, respectively. The end surface 320a and the end surface 320b may be welded, or otherwise coupled or secured, with the end surface 322a and the end surface 324a, respectively. Also, the casted member 308 may include an end surface 326a and an end surface 326b. The sidewall structure 304 and the sidewall structure 306 may include an end surface 322b and an end surface 324b, respectively. The end surface 326a and the end surface 326b may be welded, or otherwise coupled or secured, with the end surface 322b and the end surface 324b, respectively.

The bottom plate 310 may be attached to (e.g., bottom surfaces of) the casted members 302 and 308, as well as to the sidewall structures 304 and 306, via welding and/or via one or more fasteners such as screws or bolts to form the enclosure 205. In one or more implementations, a lid (not shown in FIG. and 4) may be attached to, for example, respective top, or upper, surfaces of the casted members 302 and 308, as well as respective top, or upper, surfaces of the sidewall structure 304 and 306, via welding and/or via one or more fasteners such as screws or bolts to close the enclosure 205 (e.g., after one or more battery modules, battery cells, cooling structures, and/or other electrical, structural, and/or thermal components have been installed in the cavity 314a and/or the cavity 314b).

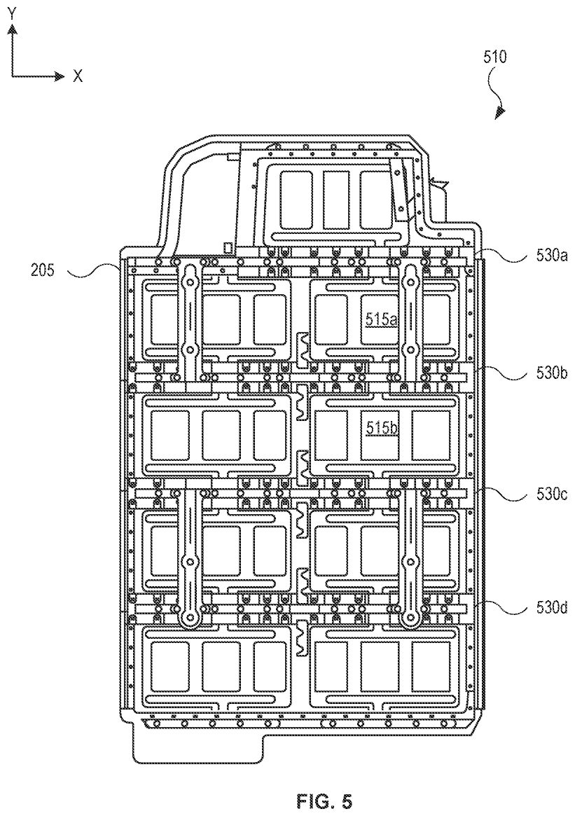

FIG. 5 illustrates an aerial view of a battery pack 510, showing several structural members of the battery pack 510 in accordance with one or more implementations of the present disclosure. For purposes of illustration, some features of the battery pack 510, such as a lid, are removed. The battery pack 510 may include any features (e.g., battery modules, battery cells, etc.) previously shown and/or described for a battery pack.

In order to provide structural support to the battery pack 510 and to provide impact resistance to the battery pack 510 and to a vehicle (e.g., vehicle 100 shown in FIG. 1A) that integrates the battery pack 510, the battery pack 510 may include a structural member 530a, a structural member 530b, a structural member 530c, and structural member 530d. Each of the structural members 530a, 530b, 530c, and 530d may couple with the enclosure 205. As shown, the structural members 530a, 530b, 530c, and 530d span, or at least substantially span, a width of the battery pack 510, with the width measured along the X-axis (in Cartesian coordinates). In this regard, the structural members 530a, 530b, 530c, and 530d may provide side impact resistance to the battery pack 510 and to a vehicle. Based in part on the orientation of the structural members 530a, 530b, 530c, and 530d, each of the structural members 530a, 530b, 530c, and 530d may take the form of a cross member assembly, or simply a cross member, that includes one or more structural supports. Each of the structural members 530a, 530b, 530c, and 530d may separate battery modules of the battery pack 510. For example, the structural member 530b separates a battery module 515a from a battery module 515b, with the battery modules 515a and 515b being part of the battery pack 510.

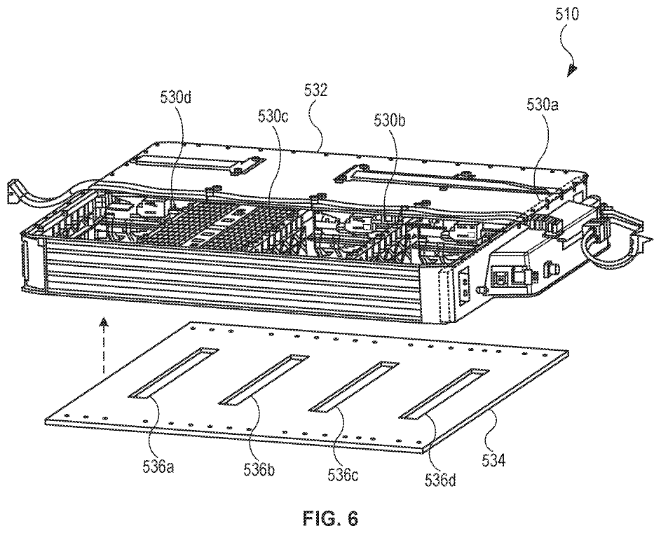

FIG. 6 illustrates a perspective view of the battery pack 510 in accordance with one or more implementations of the present disclosure. The battery pack 510 may include a lid 532. For purposes of illustration, the lid 532 is partially shown. The lid 532 may cover, or at least substantially cover, each of the structural members 530a, 530b, 530c, and 530d.

Additionally, the battery pack 510 may include a plate 534. The plate 534 may take the form of a bottom plate, similar to the bottom plate 310 (shown in FIGS. 3 and 4). The plate 534 cover and protect an underside, or bottom, of the battery pack 510. In this regard, the plate 534 may be referred to as a skid plate. The plate 534 may take the form of a metal plate or a non-metal plate, as non-limiting examples. When the plate 534 takes the form of a non-metal plate, the plate 534 may be formed form a molded polymer-based material.

The plate 534 may include several cavities. For example, the plate 534 may include a cavity 536a, a cavity 536b, a cavity 536c, and a cavity 536d. Each of the cavities 536a, 536b, 536d, and 536d may represent an indentation, blind hole, or partial opening. Each of the cavities 536a, 536b, 536d, and 536d may provide a space one or more structures, some of which may be coupled with the structural members 530a, 530b, 530c, and 530d. This will be shown and described in further detail below. Also, the plate 534 may include a cavity for each structural member of the battery pack 510.

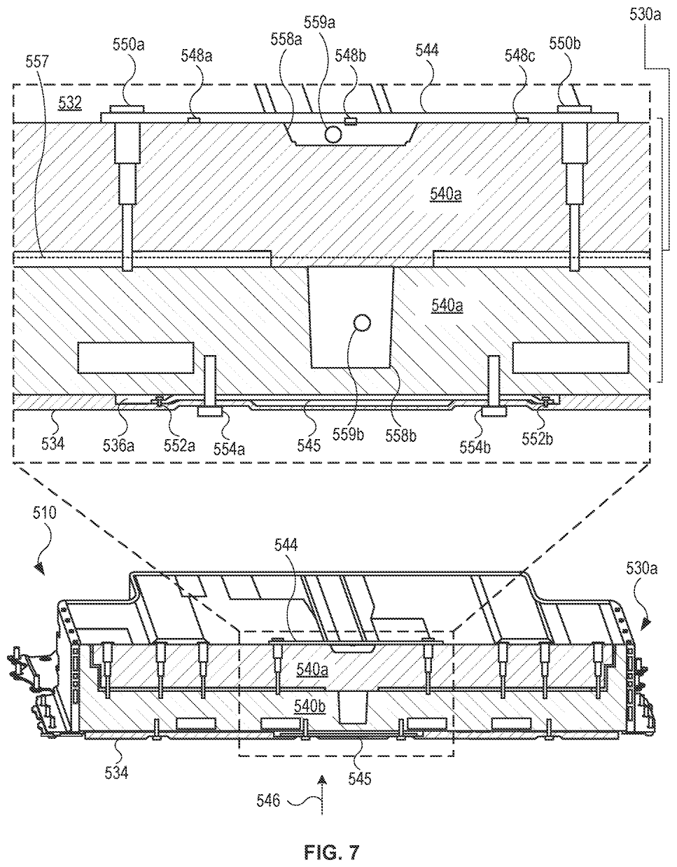

FIG. 7 illustrates a partial cross sectional view of the battery pack 510, showing an example of a structural member 530a in accordance with one or more implementations of the present disclosure. The structural member 530a and its associated features shown and/or described herein may be applicable to other structural members (e.g., structural members 530b, 530c, and 530d shown in FIGS. 5 and 6).

In one or more implementations, the structural member 530a includes multiple structural components. For example, the structural member 530a may include a structural component 540a and a structural component 540b. As shown, the structural component 540a is stacked over the structural component 540b. Also, the structural components 540a and 540b may include different shapes. For example, the structural component 540a may include a shape that is complementary to the structural component 540b, and vice versa. In this regard, the structural components 540a and 540b may include different areas. The structural components 540a and 540b may provide structural integrity along the width of the battery pack 510. When the structural member 530a takes the form of a cross member assembly that includes at least two structural components, each of the structural components 540a and 540b may be referred to as a cross member component or cross component.

In order to support the structural member 530a, the battery pack 510 may integrate additional components. For example, the battery pack 510 may include a strap 544 and a strap 545. Each of the straps 544 and 545 may be coupled (e.g., secured) with the structural member 530a. The straps 544 and 545 may include a metal (e.g., steel). However, other durable non-metals (e.g., carbon fiber) may be used. Also, each of the straps 544 and 545 may be referred to as a bar or a support, as non-limiting examples. Based on their respective locations, the strap 544 may be stacked over the strap 545 and are couple with opposite, or opposing, portions of the structural member 530a. As shown, the number of straps above the structural member 530a is the same as the number of straps below the structural member 530a. While the structural member 530a is shown as having a pair of straps (e.g., straps 544 and 545), the number of straps may vary.

The straps 544 and 545 may be designed counter, offset, or at least partially withstand, at least some applied forces. For example, an applied force in the general direction of an arrow 546 may be applied to the structural member 530a by passing through the plate 534. As a result, each of the straps 544 and 545 may bend, causing the straps 544 and 545 to be pulled in tension. When the straps 544 and 545 are pulled in tension, the straps 544 and 545 may apply a counterforce to the applied force. Beneficially, based on the straps 544 and 545, the structural member 530a is more likely to withstand bending, cracking, or breaking from the applied force. Referring to FIG. 5, having straps (e.g., straps similar to the straps 544 and 545 shown in FIG. 7) coupled with the centrally located structural components (e.g., the structural members 530b and 530c) may benefit the battery pack 510 by reinforcing a central location of the battery pack 510, thus reducing the potential structural vulnerabilities at the central location of the battery pack 510. Also, although not expressly shown, each of the straps 544 and 545 may include a coating designed to withstand corrosion.

As shown in the enlarged view, the straps 544 and 545 may secure with various components of the battery pack 510. For example, the strap 544 may couple with the lid 532. In one or more implementations, the strap 544 is welded to the lid 532, based on a spot weld 548a, a spot weld 548b, and a spot weld 548c, as non-limiting examples. In one or more implementations, the strap 544 and the lid 532 are part of a pre-assembly (e.g., prior to coupling the lid 532 with the other components of the battery pack 510). The strap 544 and the lid 532 may be coupled with the structural component 540a of the structural member 530a using several fasteners. For example, a fastener 550a and a fastener 550b may pass through respective openings of the strap 544 and the lid 532, as well as pass through respective openings of the structural component 540a of the structural member 530a to secure with the structural component 540a.

Further, the strap 545 may couple with the plate 534 using a fastener 552a and a fastener 552b. The strap 545 may be located in the cavity 536a of the plate 534. The strap 545 and the plate 534 may be coupled with the structural component 540b of the structural member 530a using several fasteners. For example, a fastener 554a and a fastener 554b may pass through the strap 545 and the plate 534, as well as secure with the structural component 540b of the structural member 530a. In one or more implementations, the strap 545 and the plate 534 are part of a pre-assembly (e.g., prior to coupling the plate 534 with the other components of the battery pack 510). The fasteners 550a, 550b, 552a, 552b, 554a, and 554b may take the form of a variety of fasteners. As non-limiting examples, each of the fasteners 550a, 550b, 552a, 552b, 554a, and 554b may take the form of a threaded fastener, a bolt, a threaded bolt, or a rivet.

Further, an imaginary line 557 extends through a center of the structural member 530a. The imaginary line 557 may represent a neutral axis of the structural member 530a. In this regard, the imaginary line 557 represents a line (or part of a plane in two dimensions) in which there is no extension or compression to the structural member 530a when structural member 530a is bent. As shown, the straps 544 and 545 may be positioned or placed as far from a neutral axis possible by being mounted to respective outer portions of the structural member 530a. Beneficially, the straps 544 and 545 are positioned to better withstand applied forces.

The structural member 530a may include features to accommodate various components of the battery pack 510. For example, the structural component 540a of the structural member 530a may include an indentation 558a that provides an opening in the structural component 540a for a fluid line 559a (representative of one or more fluid lines) designed to supply a cooling fluid to battery cells (not shown in FIG. 7) of the battery pack 510. The indentation 558a may be located (e.g., centrally located) between the fasteners 550a and 550b, including respective openings that receive the fasteners 550a and 550b. When the battery pack 510 is assembled, the lid 532 may cover the indentation 558a. Additionally, the strap 544 may cover the indentation 558a. Alternatively, the indentation 558a may substituted with an opening or gap surrounded on all sides by a portion of the structural component 540a. Also, the structural component 540b of the structural member 530a may include an opening 558b, or gap, for a fluid line 559b (representative of one or more fluid lines) designed to supply a cooling fluid to battery cells (not shown in FIG. 7) of the battery pack 510.

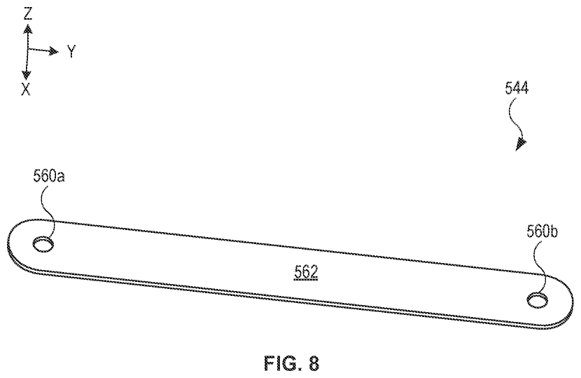

FIG. 8 illustrates a perspective view of the strap 544 in accordance with one or more implementations of the present disclosure. As shown, the strap 544 may include an opening 560a and an opening 560b, each of which may be designed to receive a fastener (e.g., the fastener 550a and the fastener 550b, respectively, shown in FIG. 7). Also, the strap 544 may include a surface 562 representing a major surface. The surface 562 may lie, or at least substantially lie, on a plane (e.g., X-Y plane). In this regard, the strap 544 may take the form of a planar, or flat, strap. The strap 544 may include a symmetric shape in that a line passing through either the X- or Y-axis can split the strap 544 into two equal portions.

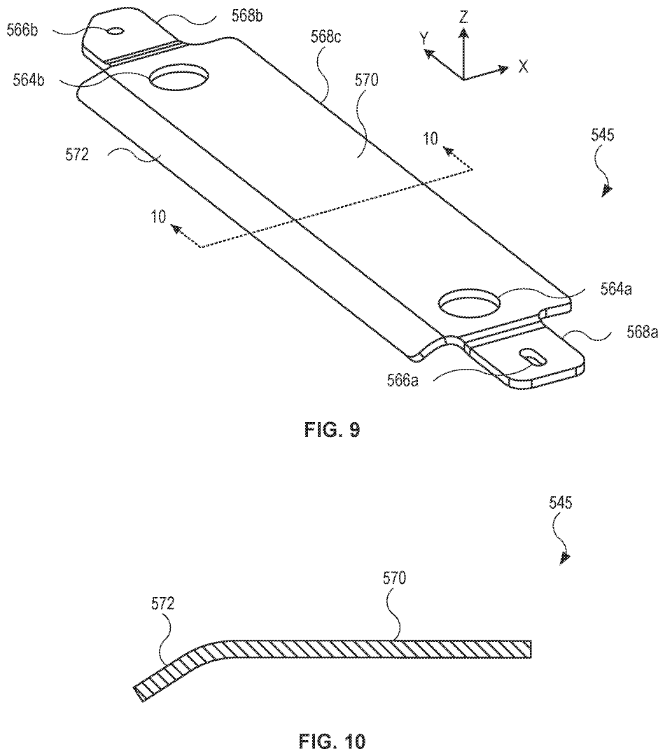

FIG. 9 illustrates a perspective view of the strap 545 in accordance with one or more implementations of the present disclosure. As shown, the strap 545 may include an opening 564a and an opening 564b, each of which may be designed to receive a fastener (e.g., the fastener 554a and the fastener 554b, respectively, shown in FIG. 7). Additionally, the strap 545 may include an opening 566a and an opening 566b, each of which may be designed to receive a fastener (e.g., the fastener 552a and the fastener 552b, respectively, shown in FIG. 7).

Also, the strap 545 may include different portions at different elevations. For example, the strap 545 may include a portion 568a (that includes the opening 566a), a portion 568b (that includes the opening 566b), and a portion 568c (that includes the openings 564a and 564b). Each of the portions 568a and 568b may take the form of a plate portion that lies on a plane (e.g., X-Y plane). The portion 568c, which is positioned between portions 568a and 568b, may take the form of a plate portion that lies on a different plane (e.g., different X-Y plane) than that of the portions 568a and 568b. As shown, the portion 568c lies on an elevated plane with respect to the portions 568a, and 568b, thus the portion 568c (e.g., central portion, middle portion) is elevated with respect to the portions 568a and 568b.

Further, the portion 568c may include both a planar portion and a non-planar portion. For example, the portion 568c may include a planar portion 570, representing a planar, or flat, portion. The portion 568c may further include a non-planar portion 572. The non-planar portion 572 may be characterized as a curved portion, as the non-planar portion 572 may not lie on a flat plane. As shown, the non-planar portion 572 may extend from the planar portion 570. By incorporating both a planar portion 570 and a non-planar portion 572, the strap 545 may include additional material for added durability, and also accounting for other features. The strap 545 may include a design that accommodates, or extends around/over, other components, such as the plate 534 (shown in FIG. 7), including portions of the plate 534 used to receive fasteners (e.g., fasteners 554a and 554b (shown in FIG. 7). The strap 545 may include an asymmetric shape in that a line cannot pass through either the X- or Y-axis and split the strap 545 into two equal portions.

FIG. 10 illustrates a cross sectional view of the strap 545 shown in FIG. 9, taken along line 10-10 in accordance with one or more implementations of the present disclosure. As shown, the planar portion 570 is flat, or substantially flat, and the non-planar portion 572 is curved and extends from the planar portion 570.

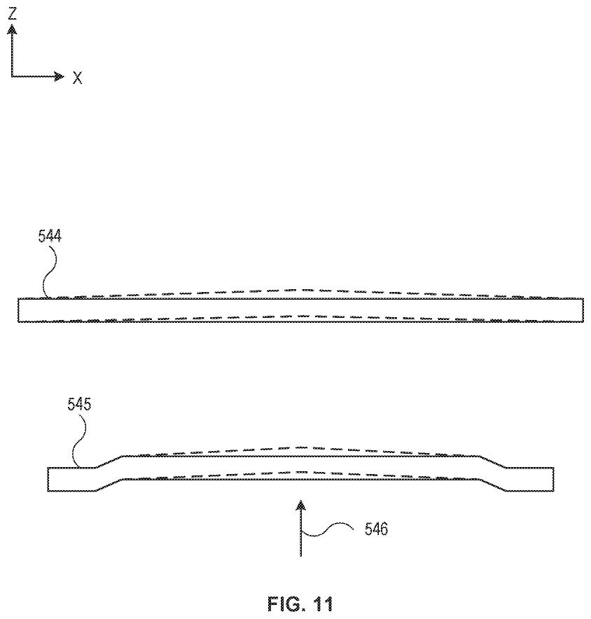

FIG. 11 illustrates a side view of the straps 544 and 545 shown in FIGS. 8 and 9, further showing the straps 544 and 545 responding to an applied force in accordance with one or more implementations of the present disclosure. For purposes of illustration and simplicity, the straps 544 and 545 are shown in isolation. As shown, the applied force in the direction of the arrow 546 represents an applied force in the Z-direction (e.g., in a direction of an underside of a vehicle). The dotted lines represent bending of the straps 544 and 545. The resultant bending of the straps 544 and 545 may pull each of the straps 544 and 545 in tension. As a result, the straps 544 and 545, under tension, may resist further bending and provide a counterforce. Put another way, the straps 544 and 545 may respond by attempting to bend back to their original, unbent shape, thus providing a counterforce. The counterforce provided by the straps 544 and 545 may provide added strength to structural members, such as the structural member 530a (shown in FIG. 7) as well as other structural members shown and/or described herein.

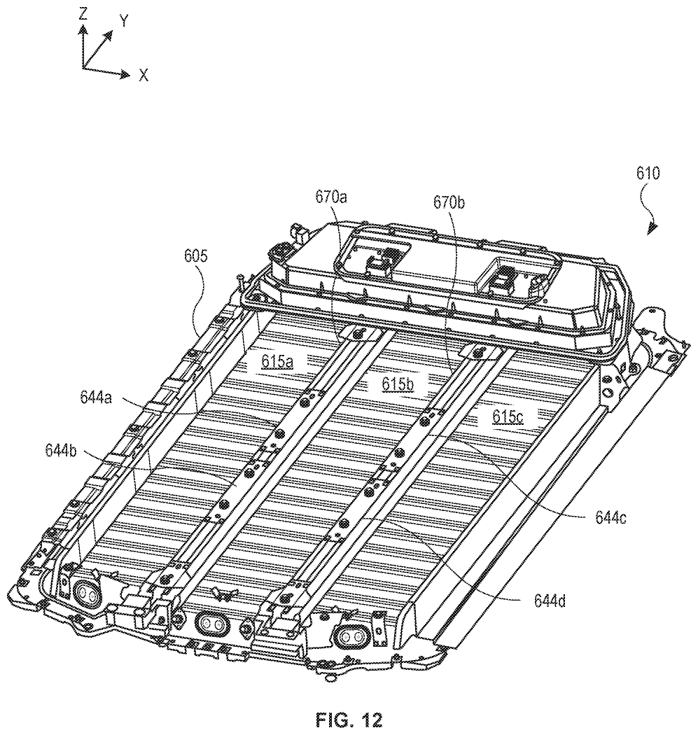

FIG. 12 illustrates a perspective view of an alternate example of a battery pack 610 and structural members in accordance with one or more implementations of the present disclosure. For purposes of illustration, some features of the battery pack 610, such as a lid, are removed. The battery pack 610 may include any features (e.g., battery modules, battery cells, etc.) previously shown and/or described for a battery pack.

In order to provide structural support to the battery pack 610 and to provide impact resistance to the battery pack 610 and to a vehicle (e.g., vehicle 100 shown in FIG. 1A) that integrates the battery pack 610, the battery pack 610 may include a structural member 670a and structural member 670b. Each of the structural members 670a and 670b may couple with an enclosure 605 of the battery pack 610. As shown, the structural members 670a and 670b span, or at least substantially span, a length of the battery pack 610, with the length measured along the Y-axis (in Cartesian coordinates), as opposed to battery packs in which structural members span the width (e.g., battery pack 510 and structural members 530a, 530b, 530c, and 530d shown in FIG. 5). In one or more implementations, the structural members 670a and 670b span a length of the battery modules 615a, 615b, and 615c. Similar to prior structural members shown and/or described herein, the structural members 670a and 670b may provide front and rear impact resistance to the battery pack 610 and to a vehicle. Based in part on the orientation of the structural members 670a and 670b, each of the structural members 670a and 670b may take the form of a longitudinal member assembly, or simply a longitudinal member, that includes a longitudinal component or multiple longitudinal components. Each of the structural members 670a and 670b may separate battery modules of the battery pack 610. For example, the structural member 670a separates a battery module 615a from a battery module 615b, and the structural member 670b separates the battery module 615b from a battery module 615c. The battery modules 615a, 615b, and 615c are part of the battery pack 610.

Also, the structural member 670a and 670b may include one or more straps. For example, the structural member 670a may include a strap 644a and a strap 644b. Also, the structural member 670b may include a strap 644c and a strap 644d. The straps 644a, 644b, 644c and 644d may include any material and provide any function previously described for the strap 544 (shown in FIGS. 7 and 8). Although not shown, each of the structural members 670a and 670b may further include one or more straps, similar to the strap 545 (shown in FIGS. 7 and 9), aligned in a stacked configuration (e.g., similar to the straps 544 and 545 shown in FIG. 7). Accordingly, each of the structural members 670a and 670b may further include one or more upper straps (e.g., straps 644a and 644b of 670a) similar to the strap 544 shown in FIG. 7, as well as one or more lower straps (e.g., similar to the strap 545 shown in FIG. 7).

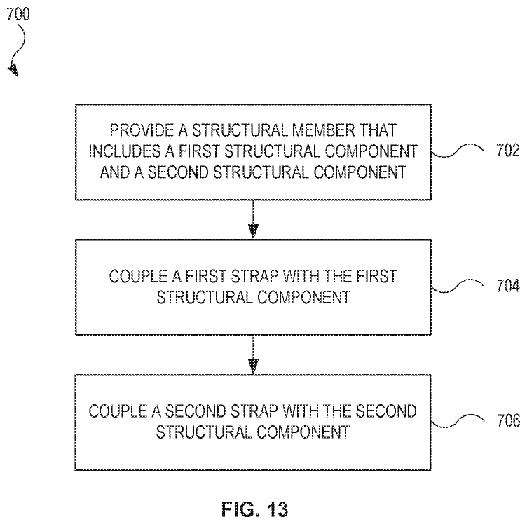

FIG. 13 illustrates a flow diagram showing an example of a process 700 that may be performed for assembling a battery subassembly in accordance with one or more implementations of the present disclosure. For explanatory purposes, the process 700 primarily described herein with reference to the battery packs and structural components, at least some of which is shown and/or described in FIGS. 5-12 and the accompanying portions of this detailed description. However, the process 700 is not limited to the battery packs and structural components shown and/or described in FIGS. 5-12, and one or more blocks (or operations) of the process 700 may be performed by one or more other components of other suitable moveable apparatuses, devices, or systems. Further for explanatory purposes, some of the blocks of the process 700 are described herein as occurring in serial, or linearly. However, multiple blocks of the process 700 may occur in parallel. In addition, the blocks of the process 700 need not be performed in the order shown and/or one or more blocks of the process need not be performed and/or can be replaced by other operations.

At block 702, a structural member is provided. The structural member may include a first structural component and a second structural component. The first structural component may be stacked over the second structural component. In one or more implementations, the structural member takes the form of a cross member assembly, or cross member. In this regarding, the structural member may include one or more structural components, and each of which make take the form of a cross member component. Alternatively, in one or more implementations, the structural member takes the form of a longitudinal member assembly, or longitudinal member. In this regarding, the structural member may include one or more structural components, and each of which make take the form of a longitudinal member component.

At block 704, a first strap is coupled with the first structural component. The first strap may cover an upper region of the first structural component, and accordingly, an upper region of the structural member.

At block 706, a second strap is coupled with the second structural component. The second strap may cover a lower region of the second structural component, and accordingly, a lower region of the structural member. Each of the first strap and the second strap may be configured to be pulled in tension and counter an applied force to the structural member.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

When an element is referred to herein as being “connected” or “coupled” to another element, it is to be understood that the elements can be directly connected to the other element, or have intervening elements present between the elements. In contrast, when an element is referred to as being “directly connected” or “directly coupled” to another element, it should be understood that no intervening elements are present in the “direct” connection between the elements. However, the existence of a direct connection does not exclude other connections, in which intervening elements may be present.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. An apparatus, comprising:
a structural member having a first portion and a second portion opposite the first portion, the structural member positioned in a battery subassembly;
a first strap coupled to the first portion; and
a second strap coupled to the second portion.

2. The apparatus of claim 1, wherein:
the first strap comprises a first metal strap bolted to the first portion, the first strap comprising a first shape, and
the second strap comprises a second metal strap bolted to the second portion, the second strap comprising a second shape different from the first shape.

3. The apparatus of claim 1, wherein:
the first strap is welded to a lid, and
the lid is configured to cover the battery subassembly.

4. The apparatus of claim 1, wherein:
the structural member comprises an indentation, and
the first strap is positioned over the indentation.

5. The apparatus of claim 4, wherein the structural member comprises:
a first structural component coupled with the first strap and comprising the indentation, and
a second structural component coupled with the second strap and comprising an opening configured to receive one or more fluid lines.

6. The apparatus of claim 5, wherein:
the first strap is coupled with the first structural component by i) a first fastener passing through the first structural component and ii) a second fastener passing through the first structural component, and
the indentation is disposed between the first fastener and the second fastener.

7. The apparatus of claim 1, wherein:
the second strap comprises an asymmetric shape, and
based on the asymmetric shape, the second strap is configured to be positioned in a cavity of a skid plate coupled with the battery subassembly.

8. The apparatus of claim 7, wherein the asymmetric shape of the second strap comprises:
a first plate portion comprising a first opening;
a second plate portion comprising a second opening; and
a third plate portion positioned between the first plate portion and the second plate portion, the third plate portion elevated with respect to the first plate portion and the second plate portion, wherein the third plate portion comprises a planar portion a non-planar portion extending from the planar portion.

9. The apparatus of claim 8, wherein the structural member comprises a cross member assembly that includes a first cross member component and a second cross member component.

10. A battery subassembly, comprising:
an enclosure that form in part a frame;
a first strap; and
a structural member coupled with the enclosure and the first strap, wherein the first strap is configured to prevent the structural member from bending based on an applied force to the frame.

11. The battery subassembly of claim 10, further comprising a second strap coupled with the structural member and configured to further prevent the structural member from bending based on the applied force.

12. The battery subassembly of claim 11, further comprising a skid plate, wherein:
the skid plate comprises a cavity, and
the second strap is located in the cavity and coupled with the skid plate.

13. The battery subassembly of claim 12, further comprising a lid that covers the structural member, wherein the first strap is welded to the lid.

14. The battery subassembly of claim 11, wherein:
the first strap comprises a symmetric shape, and
the second strap comprises an asymmetric shape.

15. The battery subassembly of claim 11, further comprising a battery module, wherein the structural member comprises a longitudinal member that spans a length of the battery module.

16. The battery subassembly of claim 10, wherein:
the structural member comprises an indentation, and
the first strap covers the indentation.

17. A vehicle, comprising:
a battery subassembly comprising a plurality of straps coupled with a cross member assembly, wherein the plurality of straps are configured to be pulled in tension in response to an applied force to the battery subassembly or a skid plate covering the cross member assembly.

18. The vehicle of claim 17, wherein the plurality of straps comprise:
a first metal strap coupled with a first cross member of the cross member assembly, and
a second metal strap coupled with a second cross member of the cross member assembly.

19. The vehicle of claim 18, further comprising a lid that covers the battery subassembly, wherein the first metal strap is coupled with the lid.

20. The vehicle of claim 17, wherein the plurality of straps are bolted to opposing ends of the cross member assembly.
